(19) United States
(12) Patent Application Publication
(10) Pub. No.: US 2010/0241268 A1
(43) Pub. Date: Sep. 23, 2010

(54) METHOD AND SYSTEM FOR DISTRIBUTING OBJECTS ON LOCATIONS

(75) Inventors: Thomas HEBISCH, Hamburg (DE); Julia SCHÜTZE, Stade (DE)

Correspondence Address: INGRASSIA FISHER & LORENZ, P.C., 7010 E. COCHISE ROAD, SCOTTSDALE, AZ, 85253, US

(73) Assignee: AIRBUS OPERATIONS GMBH, Hamburg (DE)

(21) Appl. No.: 12/789,281

(22) Filed: May 27, 2010

Related U.S. Application Data
(63) Continuation-in-part of application No. PCT/EP2007/063018, filed on Nov. 29, 2007.

(51) Int. Cl. G06F 17/00

(52) U.S. Cl. 700/214; 700/228; 700/227

(57) ABSTRACT

A method, a system and a computer program are provided for distributing objects on locations, in particular, for distributing components and materials to different locations of an assembly line. Controlling data is provided to control a distribution of the objects on object delivering units. A list is generated indicating a sequence, in which the objects have to be located on the object delivering units, depending on the controlling data. The objects are placed on the object delivering units in accordance with the list, and the object delivering units are moved to the locations.

### CROSS-REFERENCE TO RELATED APPLICATIONS

This is a continuation in part of International Application No. PCT/EP2007/063018, filed Nov. 29, 2007, which is hereby incorporated by reference in its entirety.

### TECHNICAL FIELD

The technical field relates to a method, a system and a computer program for distributing objects on locations.

### BACKGROUND

The distribution of objects plays an important role in the field of assembling, for example, in the field of assembling aircrafts. A lot of objects, in particular components and materials, are used at different locations of an assembly line. If some components are needed at a location of the assembly line, they are transported from a warehouse, in which they are stored, to the respective location. Since the number of components and materials needed for assembling an aircraft is quite large, it takes a lot of time to search for the needed component and to transfer it from the warehouse to the respective location.

It is therefore at least one object of the invention to provide a method, a system and a computer program for distributing objects on locations, which optimize the distribution process such that the time, which is needed to distribute these objects, is reduced. It is a further object of the invention to provide a method, a system and a computer program for distributing objects on locations, which can easily be adapted to present distribution requirements. For example, if it is required that some components are transferred to the same location or to neighbouring locations, the method, the system and the computer program for distributing different objects should easily be adaptable to consider this distribution requirement to optimize the distribution process, for example, by transporting these components on the same object delivering unit. In addition, other objects, desirable features, and characteristics will become apparent from the subsequent summary and detailed description, and the appended claims, taken in conjunction with the accompanying drawings and this background.

### SUMMARY

A method is provided for distributing objects on locations. The method comprises following steps: providing controlling data to control a distribution of the objects on object delivering units, generating a list indicating a sequence, in which the objects have to be located on the object delivering units, depending on the controlling data, placing the objects on the object delivering units in accordance with the list, and moving the object delivering units to the locations.

The list is generated depending on the controlling data, and the objects, which have to be delivered to the locations, are placed on the object delivering units in accordance with the list, i.e., the controlling data control the distribution of the objects on the object delivering units, which are moved to the locations. Therefore, the controlling data control the distribution process. By modifying the controlling data the distribution process can easily be adapted to present distribution requirements such that the distribution process is optimized, in particular, such that the time, which is needed to distribute these objects, is reduced. For example, if it is required that some objects are delivered to the same location, the controlling data can be adapted such that these objects are placed on the same object delivering unit.

Controlling data are, for example, data specifying that objects, which have to be delivered to the same location, have to be placed on the same object delivering unit. Another example for controlling data are data which identify objects, which are needed at neighbouring locations at the same time and which specify that these objects have to be placed on the same object delivering unit. Further examples for controlling data will be described further below.

It is preferred, that the list indicates the sequence, in which the objects have to be placed on the object delivering units, by indicating a sequence, in which containers have to be located on the object delivering units, wherein to each container at least one object is assigned, which has to be placed in the container. This allows to group objects within one container, which have to be used, for example, during the same assembling step or during assembling steps, which are related to each other, for example, because the assembling steps have to be performed at the same location and/or because the assembling steps have to be performed by the same person consecutively. Thus, by grouping objects in containers, the distribution process can be further improved.

It is further preferred, that orders are defined, which comprise objects, and wherein to each container at least one object is assigned by assigning to each container at least one order. The orders comprise preferentially information indicating which assembling steps have to be performed at which location and at which time. The orders further comprise the objects, which, for example, are needed for the assembling steps of the respective order. Thus, by assigning to each container an order, objects, which are related to the order, for instance, which are related to the assembling steps of the order, are grouped within the same container, wherein the distribution process is further improved.

In an embodiment according to the invention, after generating the list, each container which is indicated by the list, is labelled with a first label indicating the order, which is assigned to the container, and each object is labelled with a second label indicating the order to which the object corresponds. Since each container is labelled with a first label indicating the order, which is assigned to the container, and since each object is labelled with a second label indicating the order to which the object corresponds, each object can easily be placed in the corresponding container by comparing the orders of the first label and the second label, wherein the distribution of the objects among the containers and thus among the object delivering units is accelerated.

In a further embodiment according to the invention, groups of controlling data are provided, wherein the groups comprise a ranking, and wherein the list is generated depending on the ranking. The ranking allows to give controlling data of different groups, different ranking positions, wherein, if the control, which is generated by control data of one group, is in conflict with a control, which is generated by control data of another group, the control of the control data of the group comprising the higher ranking position will be used. This weighting of controlling data further improves the adaptability of the distribution process.

It is preferred, that after containers have been located on an object delivering unit, and the assignment of the containers to the object delivering unit is registered. Since, after registration, it is known, on which object delivery unit a container and therefore an object is located, this allows to monitor the distribution of the containers and the objects. In particular, the movement of the object delivering units is traced, which improves the monitoring of the distribution process.

In an embodiment according to the invention, to each object delivering unit a status is assigned depending on the location of the object delivering unit, wherein the movement of the object delivering units is restricted to a movement, which comprises only predetermined status transitions. The predetermined status transitions are predetermined such that the distribution process is further improved. Therefore, by restricting the movement of the object delivering units to these predetermined status transitions, the distribution process is further improved.

It is further preferred, that, before the objects are placed on the object delivering units, the objects are stored in a warehouse at locations, which depend at least on a part of the controlling data. Since the objects are stored in a warehouse at locations, which depend at least on a part of the controlling data, the storage of the objects in the warehouse is adapted to the distribution of the objects among the containers and among the object delivering units. Therefore, the stock removal and the transfer from the warehouse to the containers and the object delivering units are accelerated.

The above mentioned objects are further achieved by a system for distributing different objects on locations, wherein the system comprises: means for providing controlling data to control a distribution of the objects on object delivering units, means for generating a list indicating a sequence, in which the objects have to be located on the object delivering units, depending on the controlling data.

Preferentially the system is adapted to perform one or several of the above mentioned preferred steps and embodiments of the method for distributing objects on locations according to the invention.

The above mentioned objects are further archived by a computer program for distributing different objects on locations for carrying out the steps of providing controlling data to control a distribution of the objects on object delivering units, generating a list indicating a sequence, in which the objects have to be located on the object delivering units, depending on the controlling data, when the computer program is run on a computer, wherein the computer program comprises: first program code means for providing controlling data to control a distribution of the objects on object delivering units and second program code means for generating a list indicating a sequence, in which the objects have to be located on the object delivering units, depending on the controlling data.

Preferentially the computer program is adapted to perform one or several of the above mentioned preferred steps and embodiments of the method for distributing objects on locations according to the invention.

### BRIEF DESCRIPTION OF THE FIGURES

The present invention will hereinafter be described in conjunction with the following drawing figures, wherein like numerals denote like elements, and

FIG. 1 shows schematically an embodiment of a system for distributing objects on locations;

FIG. 2 shows schematically an object delivering unit with containers and objects;

FIG. 3 shows schematically a container containing an object; and

FIG. 4 shows a flowchart of an embodiment of a method for distributing objects on locations.

### DETAILED DESCRIPTION

The following detailed description is merely exemplary in nature and is not intended to limit application and uses. Furthermore, there is no intention to be bound by any theory presented in the preceding background or summary or the following detailed description.

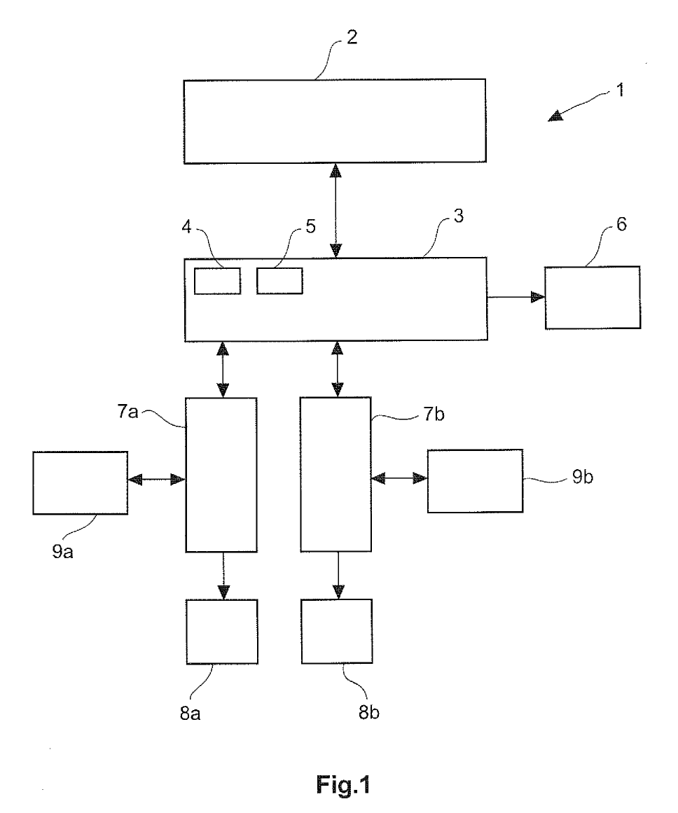

FIG. 1 shows an embodiment of a system 1 for distributing objects on locations. The system 1 for distributing objects on locations comprises a management system 2, which is, for example, a SAP-system, which performs, for example, inventory management and missing object management. The management system 2 provides also orders.

An order describes preferentially one or a group of assembling steps, which are needed to assemble a part of, for example, an aircraft. The order comprises preferentially further the time, at which the assembling steps have to be performed, and the objects, which are needed to perform, these assembling steps. Objects are, in particular, components, which are needed to assemble the aircraft.

The system 1 for distributing objects on locations further comprises a distribution system 3, which determines the distribution of the objects among containers and among object delivering units. The management system 2 is connected to the distribution system 3 to transfer the orders from the management system 2 to the distribution system 3. The distribution system 3 comprises means 4 for providing controlling data to control a distribution of the objects on object delivering units. The distribution means is preferentially a computer, and the means for providing controlling data is preferentially a data bank.

The locations, at which the objects have to be distributed, are preferentially classified into stations and building sites. Each station comprises several building sites. For example, if an aircraft is assembled along an assembling line, the stations can be distributed along the assembling line indicating different larger assembling regions, and at each station several building sites can be present, wherein each building site indicates a smaller assembling region being a part of the larger assembling region.

The controlling data can comprise first data, which group orders and therefore objects, which have to be used at the same station, together resulting in first groups. Depending on these first data a list will be generated such that objects of different first groups are placed on different object delivering units.

The controlling data can comprise second data, which indicate the time at which the order has to be performed, and therefore the delivering time at which the corresponding objects have to be at the corresponding station or building site. These second data are preferentially determined from the orders. Depending on these second data a list will be generated such that objects having different delivering times will be placed on different object delivering units.

The controlling data can further comprise third data, which group building sites resulting in second groups and which assign the orders received from the management system 2 to the different second groups of building sites. A second group can also comprise only one building site. Objects, which correspond to orders assigned to different second groups of building sites, are preferentially not allowed to be placed on the same object delivering unit. Thus, depending on the third data a list will be generated, wherein objects of different second groups are distributed on different object delivering units.

The controlling data can comprise fourth data, which group the orders depending on the technical assembling field resulting in third groups, wherein orders and therefore objects, which correspond to these orders, of different third groups, i.e., which correspond to different technical assembling fields, are not allowed to be placed on the same object delivering unit. Thus, depending on the fourth data, the list will be generated accordingly. Different technical assembling fields are for example, hydraulic, electrical and mechanical assembling.

It is also preferred, that the controlling data comprise data, which group predetermined orders and therefore objects because of other reasons together resulting in fourth groups, for example, because these orders have to be carried out by one person or because the objects are needed at neighbouring building sites. It is preferred, that it is not allowed to place orders and therefore the corresponding objects of different groups on the same object delivering unit. The list will be generated accordingly.

The controlling data can further comprise fifth data, which assign to each container an object delivering unit of a predetermined size. Furthermore, the fifth data can comprise the rule, that containers assigned to an object delivery unit of a larger size have to be placed on the object delivering units before a container is placed assigned to a smaller object delivering unit.

The control data can further comprise sixth data grouping orders and therefore objects together, which have to be placed in the same container.

Furthermore, the controlling data can comprise seventh data indicating orders, wherein the objects, which correspond to these orders, have to be placed in one container only.

The distribution system 3 further comprises a means 5 for generating a list indicating a sequence, in which the objects have to be located on the object delivering units, depending on the controlling data. The generated list is transferred to an output device 6, which outputs the generated list.

The system 1 for distributing objects on locations further comprises at least one warehouse management system 7a, 7b, which receives from the distribution system 3 the information, which orders have to be carried out and therefore which objects are needed at which time. The warehouse management system 7a, 7b determines at which locations the required objects are placed within the corresponding warehouses 8a, 8b. The required objects are removed from the warehouse and labelled with a second label which is generated by a corresponding label generation device 9a, 9b. This second label comprises information concerning the corresponding order, for example, an order identification number. The objects, which have been removed from the warehouse and labelled with the second label, are transported to a loading site, at which object delivering units are loaded with containers and with the required objects.

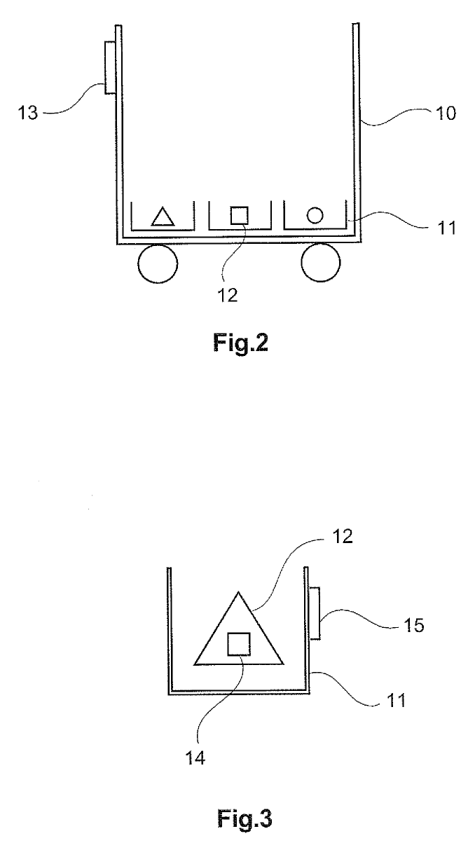

FIG. 2 shows schematically an object delivering unit 10, which has been loaded with containers 11, wherein the containers 11 contain the required objects 12. The object delivering unit 10 can be any known transporter which is suited to transport the containers and the required objects to the different locations. The object delivering units comprise third labels 13, which identify each object delivering unit 10 unambiguously.

FIG. 3 shows schematically a container 11 containing a required object 12. The container 11 is labelled with a first label 15 and the object 12 is labelled with the second label 14. The first label 15 comprises information indicating unambiguously to which order the container 11 corresponds. The second label 14 comprises information indicating unambiguously to which order the required object 12 corresponds. Therefore, if the object 12 has been placed within the container 11 correctly, the orders indicated by the first label 15 and the second label 14 are identical.

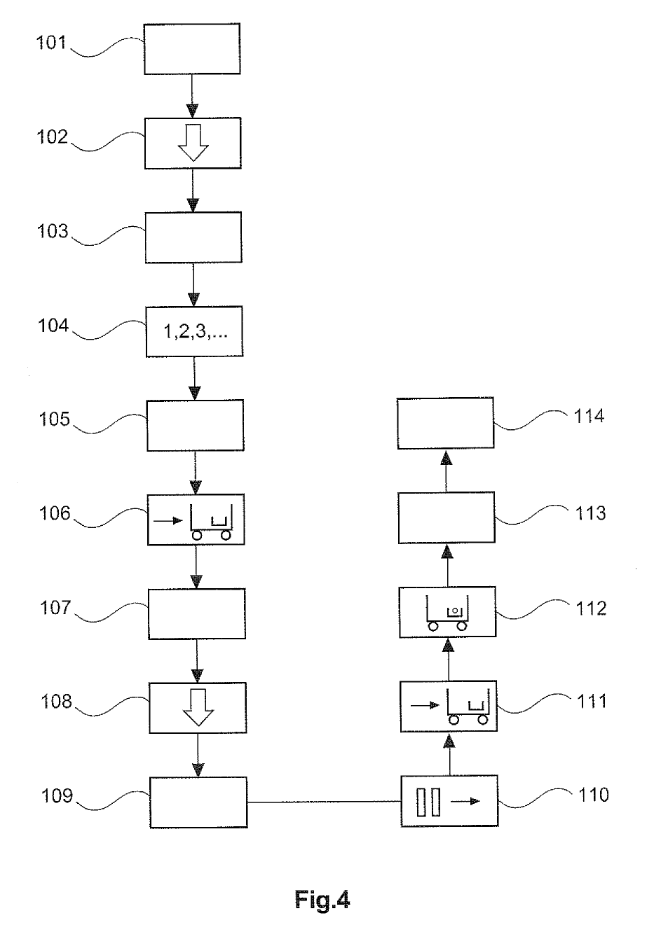

An embodiment of a method for distributing objects on locations according to the invention will now be described in more detail with respect to a flowchart shown in FIG. 4.

In step 101 objects are placed in the warehouse 8a, 8b, wherein the location of the objects within the warehouse is registered by the warehouse management system 7a, 7b. It is preferred that the information, which objects have to be placed within the warehouse, is inputted into the warehouse management system 7a, 7b, wherein the warehouse management system 7a, 7b determines, at which locations within the warehouse 7a, 7b the objects have to be placed. For the determination of the locations, at which the objects should be placed within the warehouse 8a, 8b, the warehouse management system 7a, 7b uses preferentially at least a part of the controlling data to adapt the later removal from the warehouse and the transfer from the warehouse to the loading site to the distribution process, in particular, to the process of distributing different components of an aircraft among different stations and building sites. For example, objects, which have to be placed on one object delivering unit or within one container according to the controlling data, are preferentially placed at neighbouring locations and/or on one means for transferring these objects from the warehouse to the loading site, for example, on one skid or within one bag.

In step 102 the distribution system 3 receives orders from the management system 2. In step 103 the means 4 for providing controlling data provides controlling data, which can control the distribution of the objects on the object delivering units. The means 5 for generating a list generates in step 104 a list indicating a sequence, in which the objects have to be located on the object delivering units, depending on the provided controlling data, in particular, depending on the above mentioned first to seventh data.

In this embodiment the list indicates the sequence, in which the objects have to be placed on the object delivering units, by indicating a sequence, in which containers have to be located on the object delivering units, wherein to each container an order is assigned and wherein in each container the objects or the object of the assigned order have to be placed. Thus, in this embodiment the means 5 for generating a list generates a list indicating a sequence, in which containers, which are assigned to the orders, have to be located on the object delivering units.

This list is generated preferentially by using the above mentioned controlling data. For example, if the first data of the controlling data are used, the list is generated such, that objects, which have to be used at the same station, are placed on the same object delivering unit. And, if, for example, the seventh data of the controlling data are used, objects, which correspond to an order, which is specified in these seventh data, are placed within one container.

The controlling data are ranked such that, if, for example, the first data of the controlling data are in conflict with the second data of the controlling data, the second data of the controlling data will be used to generate the list, and not the first data. With respect to the first data to the seventh data of the controlling data, the data comprising a higher ordinal number overrule the data having a lower ordinal number.

After the list has been generated, the list is outputted on the output device 6. The output is preferentially a list of first labels, wherein each label comprises information indicating unambiguously one order. In particular, each label comprises a bar code identifying unambiguously an order. The first label comprises preferentially further information indicating the location, for example, the building site, to which a container has to be transported, and the type of the container, which has to be used for the order indicated on the first label. Different type of containers can comprise different dimensions, different rigidity, a different shape etc. The assignment between different objects and different types of containers is predetermined and stored in a data bank on the distribution system 3. Thus, since the orders comprise objects, to each order a type of container can be assigned and printed on the first label, which corresponds to the objects of this order.

The generated list comprises marks indicating that the next container of the list has to be placed on a new object delivering unit. Such a mark is preferentially set between two first labels of the list generated in step 104, if the delivering time of the orders corresponding to these two first labels is different, or if the orders corresponding to these first labels have to be carried out at different second groups of building sites, which are defined by the third data of the controlling data, or if the orders corresponding to these first labels correspond to different third groups, which are defined by the fourth data of the controlling data.

The outputted first labels are attached to containers of the type indicated on these first labels, and in step 106 the containers are placed on an object delivering unit until a mark indicates that a new and empty object delivering unit has to be used for the next containers of the generated list. The distribution system 3 generates also a third label, which is outputted by the output device 6. The third label is attached to the object delivering unit, on which the containers have been placed. The third label comprises preferentially the location, for example, the building site, to which the containers and therefore the object delivering unit have to be moved. Furthermore, the third label comprises preferentially the time, at which the object delivering unit has to be at the location, i.e., the delivering time.

After the containers have been placed on an object delivering unit, it is registered on the distribution system, which containers are placed on the object delivering unit. The containers are preferentially identified by consecutive numbers, which correspond to the position within the list generated in step 104. On each first label this consecutive number is shown. Furthermore, each object delivering unit comprises the third label identifying the object delivering unit unambiguously. Preferentially, the containers on the object delivering unit are registered by registering the consecutive numbers of the containers and of the information on the third label identifying the object delivering unit. Since containers are identified by consecutive numbers, the containers on an object delivering unit can be registered by registering the two containers, which have been placed as the first container and the last container on the object delivering unit. It is preferred, that the registration is carried out by using bar codes, which are located on the first and the third labels and which represent at least the consecutive number and the object delivering unit, for example, an object delivering unit number identifying the object delivering unit unambiguously.

In step 108 the orders are sent from the distribution system 3 to the warehouse management system 7a, 7b. In step 109 the warehouse management system 4 determines from the orders, which objects have to be removed from the warehouse, and the warehouse management system 4 determines, at which locations these objects are placed within the warehouse 8a, 8b. In step 110 the objects determined by the warehouse management system 7a, 7b are removed from the warehouse. Furthermore, for each object a second label is generated, which comprises the order to which the corresponding object belongs to. Each object is labelled with the corresponding second label.

In step 111 the labelled objects are transferred to a loading site, at which the object delivering units comprising the containers are located. In step 112 the objects are placed in the corresponding containers by comparing the orders on the first and the third labels. In order to place an object in the corresponding container, only the order, for example, the order number, on the third label attached to the object has to be identified, and the object has to be placed in the container, whose first label indicates the same order, in particular, the same order number.

In step 113 the object delivering unit is moved to the location indicated on the third label attached to the object delivering unit. During the movement of the object delivering unit the path of the object delivering unit is traced such that the actual position of the object delivering unit can be determined by the distribution system 3. In particular, the object delivering unit comprises a transponder, which communicates with a communication unit of the distribution system to determine the actual position of the object delivering unit. Alternatively, the system 1 for distributing objects on locations comprises several position inputting sites, which have to be passed by the object delivering unit, wherein at each position inputting site it is registered by a position inputting system, that the object delivering unit is located at the respective position inputting site. The position inputting system transfers the position information to the distribution system 3 in order to trace the movement of the object delivering unit. The position inputting system can comprise a scanner, which scans a bar code on the third label attached on the object delivering unit, which identifies the object delivering unit unambiguously.

It is preferred that to each object delivering unit a status is assigned depending on the location of the object delivering unit. For example, before the loading procedure at the loading site is carried out, the object delivering unit can have the status 0. If the object delivering unit is filled with containers and located at the loading site, the object delivering unit can have the status 1. If the object delivering unit is located between the loading site and the destination location, for example, the building site indicated on the third label, the status can be 2. If the object delivering unit is located at the destination location, the status can be 3, and if the object delivering unit is empty and on the way back to the loading site, the status can be 4. These statuses are only examples. Also, other statuses can be defined which depend on the location of the object delivering unit. During the movement of the object delivering unit the transitions between different statuses are observed by the distribution system 3. The movement is restricted to predetermined status transitions only. If the object delivering unit performs a status transition, which is not allowed, the distribution system 3 outputs a signal indicating that the movement of the object delivering unit is incorrect and that the movement has to be corrected.

In step 114 the object delivering unit has reached the final destination, for example, the building site, indicated on the third label attached to the object delivering unit, and the objects can be used to carry out the assembling steps described in the order indicated on the first label attached to the respective container. The steps 101 to 114 are, for sure, not carried out by only one object delivering unit and only one order, but for an arbitrary number of orders and a number of object delivering units, which is needed to distribute the objects identified by the orders to the locations at the delivering time, which are also identified by the order.

The objects can also be placed on the object delivering units without using containers, i.e., the objects can directly be placed on the object delivering units, or some objects can be placed within containers placed on the object delivering units and some objects can be directly placed on the object delivering units.

The list can indicate a sequence, in which the objects have to be located on the object delivering units, without using the containers, or the list can indicate a sequence, in which the objects have to be located on the object delivering units, wherein for some objects this sequence is indicated by indicating for some objects a sequence, in which containers have to be located on the object delivering units, wherein to each container at least one object is assigned, which has to be placed in the container, and by indicating for some other objects a sequence, in which the objects have to be located on the object delivering units directly.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for distributing objects on locations, comprising the steps of:
providing controlling data to control a distribution of the objects on object delivering units;
generating a list indicating a sequence, in which the objects have to be located on the object delivering units, depending on the controlling data;
placing the objects on the object delivering units in accordance with the list; and
moving the object delivering units to the locations.

2. The method of claim 1, wherein the list indicates the sequence, in which the objects have to be placed on the object delivering units, by indicating a sequence, in which containers have to be located on the object delivering units, and each container is assigned at least one object.

3. The method of claim 2, further comprising the step of defining orders that comprise objects, and wherein to each container is assigned the at least one object by assigning to each container at least one order.

4. The method of claim 3, wherein, after generating the list, each container, which is indicated by the list, is labelled with a first label indicating the order, which is assigned to a container, and each object is labelled with a second label indicating the order to which the object corresponds.

5. The method of claim 1, further comprising the step of providing the controlling data comprising a ranking and generating the list depending on the ranking.

6. The method of claim 2, further comprising the step of registering an assignment of the containers to the object delivering unit after containers have been located on an object delivering unit.

7. The method of claim 1, further comprising the step of tracing movement of the object delivering units.

8. The method of claim 1, further comprising the steps of:
assigning a status to each object delivering unit depending on a location of an object delivering unit; and
restricting movement of the object delivering units, which comprises only predetermined status transitions.

9. The method of claim 1, further comprising the step of storing the objects in at least one warehouse at the locations that depend at least on a part of the controlling data before the objects are placed on the object delivering units.

10. A system for distributing different objects on locations, said system comprises:
a data controller adapted to provide controlling data to control a distribution of the objects on object delivering units; and
a generator adapted to generate a list indicating a sequence, in which the objects have to be located on the object delivering units depending on the controlling data.

11. A computer readable medium embodying a computer program product, said computer program product comprising:
a computer program for distributing different objects on locations, the computer program for distributing different objects on the locations configured to:
providing controlling data to control a distribution of the objects on object delivering units;
generating a list indicating a sequence, in which the objects have to be located on the object delivering units, depending on the controlling data;
placing the objects on the object delivering units in accordance with the list; and
moving the object delivering units to the locations.

12. The computer readable medium embodying the computer program product of claim 11, wherein the list indicates the sequence, in which the objects have to be placed on the object delivering units, by indicating a sequence, in which containers have to be located on the object delivering units, and each container is assigned at least one object.

13. The computer readable medium embodying the computer program of claim 12, the computer program is further configured to define orders that comprise objects, and wherein to each container is assigned the at least one object by assigning to each container at least one order.

14. The computer readable medium embodying the computer program product of claim 11, the computer program is further configured to provide the controlling data comprising a ranking and generating the list depending on the ranking.

15. The computer readable medium embodying the computer program product of claim 12, the computer program is further configured to registering an assignment of the containers to the object delivering unit after containers have been located on an object delivering unit.

16. The computer readable medium embodying the computer program product of claim 11, the computer program is further configured to trace movement of the object delivering units.

17. The computer readable medium embodying the computer program product of claim 11, the computer program is further configured to:
assign a status to each object delivering unit depending on a location of an object delivering unit; and
restrict movement of the object delivering units, which comprises only predetermined status transitions.

18. The computer readable medium embodying the computer program product of claim 11, the computer program is further configured to store the objects in at least one warehouse at the locations that depend at least on a part of the controlling data before the objects are placed on the object delivering units.
